(19) United States
(12) Patent Application Publication
(10) Pub. No.: US 2007/0189814 A1
(43) Pub. Date: Aug. 16, 2007

(54) Mounting doctor blades onto developer rolls in electrophotographic printers

(76) Inventors: Jarrett C. Gayne, Lexington, KY (US); Nicholas M. Sullivan, Lancaster, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/354,696

(22) Filed: Feb. 15, 2006

(51) Int. Cl. G03G 15/08

(52) U.S. Cl. 399/284

(57) ABSTRACT

A doctor blade may be mounted between a pair of L-shaped brackets. The brackets may include a pair of opposed openings that receive mounting posts which extend outwardly from the printer housing. A pair of threaded fasteners may be used to secure the assembly of brackets and doctor blade to the housing. The L-shaped brackets may include a long end and a shorter end, the longer end supportable on a land provided on the printer housing. The longer end of one of the brackets may overlap the longer end of the other of the brackets so that the doctor blade may flex away from one of the brackets.

### BACKGROUND

This invention relates generally to electro-photographic printers that use toner to transfer an image to a medium.

In conventional electrophotographic printing, toner is transferred from a developer roll to a medium. In order to obtain a good transfer of the image, it is desirable that the toner on a developer roll be applied very evenly. Even application of toner may be facilitated by using a doctor blade that controls the thickness of the toner on the developer roll. As the developer roll rotates, the doctor blade doctors the toner applied thereto and provides a relatively uniform toner coating.

Since the application of the uniform toner coating may be critical to the performance of the printer, there is a continuing need for better doctor blade designs.

### BRIEF DESCRIPTION OF THE DRAWINGS

FIG. 1 is a partial, cross-sectional view of one embodiment of the present invention;

FIG. 2 is an exploded depiction of a developer frame in accordance with one embodiment of the present invention; and

FIG. 3 is a schematic depiction of a printer in accordance with one embodiment of the present invention.

### DETAILED DESCRIPTION

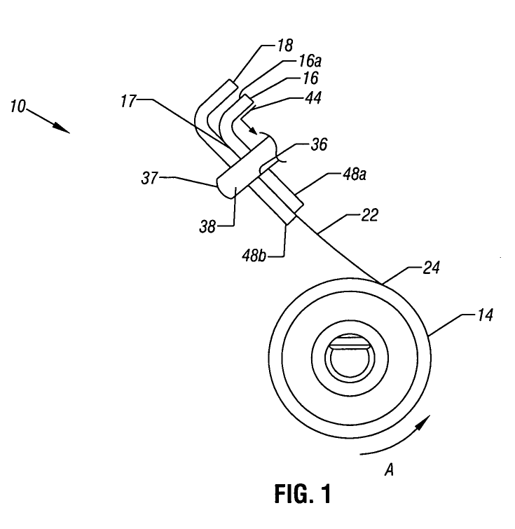

Referring to FIG. 1, a developer roll 14 rotates in the direction indicated by the arrow A. The developer roll 14 may be coated with a coating of toner (not shown). Biased against the surface of the developer roll 14 is a doctor blade 22. In one embodiment of the present invention, the doctor blade 22 is a thin, highly resilient metallic sheet that acts as a cantilevered leaf spring. For example, the doctor blade 22 may be made of spring steel in one embodiment of the present invention. The blade 22 may have a curved end 24. While a checkmark shaped end 24 is shown in FIG. 1, other end designs may be utilized as well.

As the developer roll 14 rotates in the direction indicated by A, uneven toner on the surface of the developer roll impacts the end 24 of the doctor blade 22 and is squeezed into the nip between the end 24 and the roll 14, providing a uniform thickness toner coating on the output, counterclockwise, or downstream side of the doctor blade 22.

The doctor blade 22 may be supported in a spring biased configuration against the surface of the developer roll 14 through the application of a counterclockwise applied force applied by a mounting bracket system. The mounting bracket system may include a front bracket 18 and a rear bracket 16, as well as a locating post 38 which extends through locating post apertures 36 in the front and rear brackets 16 and 18 and the doctor blade 22.

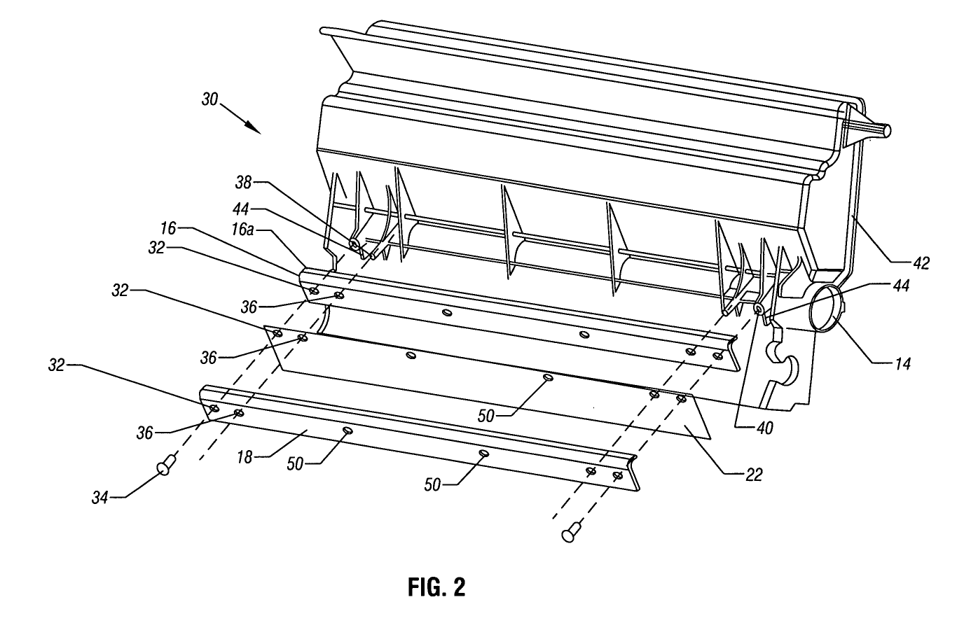

In one embodiment, each of the brackets 18 and 16 may be L-shaped, having parallel opposed surfaces 17 that clamp the doctor blade 22 between themselves. The rear bracket 16 may be arranged so that its longer leg 48a rests on lands 44 formed in the developer frame 42, as shown in FIG. 2. The brackets 16 and 18 may be nested so that they lie generally parallel to one another.

In position within the developer frame 42, shown in FIG. 2, the locating posts 38 protrude completely through the brackets 18 and 16. In some embodiments, the locating posts 38 may have curved ends 37 (FIG. 1) to facilitate their insertion through the apertures 36 in the brackets 18 and 16.

As shown in FIG. 1, the rear bracket 16 may be arranged so that the longer leg 48b of the front bracket overlaps the longer leg 48a of the rear bracket 16. This overlap allows the doctor blade 22 to flex in a counterclockwise direction away from the portion 48b due to the bias applied to the blade by the brackets 16 and 18.

Thus, in some embodiments, the brackets 16 and 18 may be substantially more rigid than the relatively resilient doctor blade 22. As a result, a consistent biasing force may be applied by the brackets 16 and 18 to the doctor blade 22, biasing the blade 22 against the surface of the developer roll 14. In one embodiment of the present invention, the doctor blade 22 makes contact with the developer roll 14 between about one and two o'clock, relative to the surface of the developer roll 14 or, taking the vertical diameter through the developer roll 14, at an angle of about 10 to 35 degrees therefrom.

Referring to FIG. 2, a developer frame 42 may be replaceably inserted within an electrophotographic printer. In other words, it may be replaceably plugged into the printer to replace consumables included in the frame 42. The developer frame 42 may include an integral toner storage and an integral developer roll 14 in one embodiment.

The front bracket 18 and the rear bracket 16 may sandwich the doctor blade 22 and bias the blade 22 against a surface of the developer roll 14. This bias is facilitated by the outwardly protruding locator posts 38 formed at two spaced locations along the length of the developer frame 42. Thus, the locating posts 38 pass through the apertures 36 in the back bracket 16, the doctor blade 22 and the rear bracket 18.

Once secured in position on the developer frame 42, the locating posts 38, near either end of the developer frame 42, protrude through the front bracket 18 as shown in FIG. 1. At this point, screws 34 may be used through two opposed openings 32 in each of the front bracket 18, doctor blade 22, and rear bracket 16. These screws 34 are secured to the developer frame 42 through molded, protruding screw holes 40 and, in one embodiment, may be threaded or threadable.

Thus, in some embodiments, through the imposition of locating posts 38 and the rigid brackets 16 and 18, only two screws may be needed to secure the assembly together, facilitating attachment. However, if greater rigidity is desired, additional screws may be used in additional openings 50 in each of the brackets 16 and 18 in doctor blade 22, securing to intermediate holes 40 (not shown), intermediate between the two mounting pads 44 shown in FIG. 2.

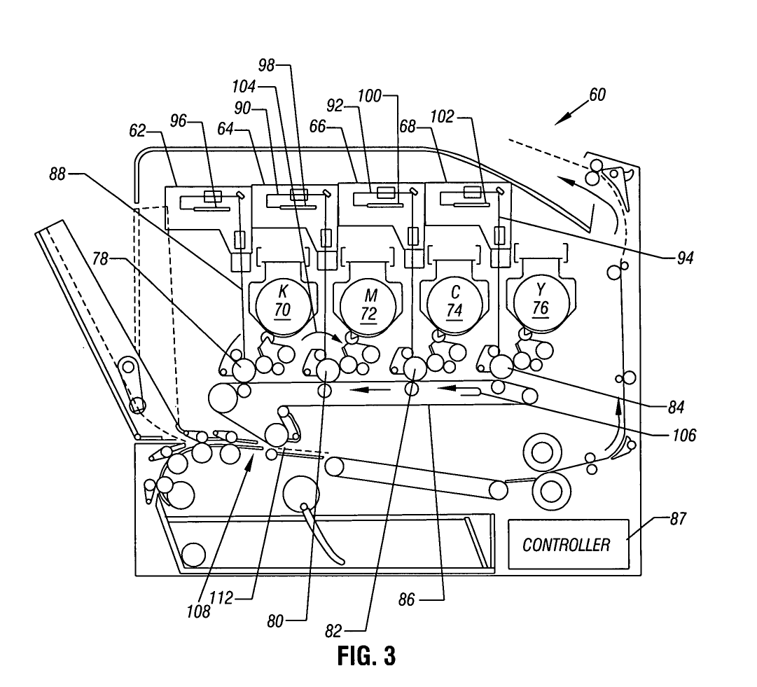

Referring to FIG. 3, there is shown one embodiment of an electro-photographic device 60 in which embodiments of the present invention may be applied. Of course the present invention is in no way limited to any specific printer design and may be applicable to a variety of different printer arrangements.

The device 60 includes laser print heads 62, 64, 66, and 68, a black toner cartridge 70, a magenta toner cartridge 72, a cyan toner cartridge 74, a yellow toner cartridge 26, photoconductive drums 78, 80, 82, and 84, an intermediate transfer belt 86, and a controller 87. In one embodiment, the controller may be a combination of application specific integrated circuits, microprocessors, and firmware suited to the tasks of printing documents.

Each of the laser print heads 62, 64, 66, and 68 projects a respective laser beam 88, 90, 92, and 94 off a respective one of the polygonal mirrors 96, 98, 100, and 102. As each of the polygonal mirrors 96, 98, 100, and 102 rotates, it scans a respective one of the reflected beams 88, 90, 92, and 94 in a scan direction, perpendicular to the plane of FIG. 3, across a respective one of the photoconductive drums 78, 80, 82, and 84.

Each of the photoconductive drums 78, 80, 82, and 84 may be negatively charged, for example, to approximately −1000 volts, and is subsequently discharged to a lower level, such as approximately −300 volts, in the areas of the peripheral surface that are impinged by a respective one of the laser beams 88, 90, 92, and 94.

During each scan of a laser beam across the photoconductive drum, each photoconductive drum 78, 80, 82, and 84 is continuously rotated, for example, in a clockwise direction, in a process direction indicated by the arrow 104. The scanning of the laser beams 88, 90, 92, and 94 across the peripheral surface of the photoconductive drums is cyclically repeated, thereby discharging the areas of the peripheral surfaces on which the laser beams impinge.

The toner in each of the toner cartridges 70, 72, 74, and 76 is negatively charged and is transported upon the surface of a developer roll 110 and biased, for example, to approximately −600 volts. Thus, when the toner for the cartridges 70, 72, 74, and 76 is brought into contact with the respective one of the photoconductive drums 78, 80, 82, and 84, the toner is attracted to and adheres to the portions of the peripheral surfaces of the drums that have been discharged to the lower voltage, say −300 volts, by the laser beams.

As the belt 86 rotates in the direction indicated by the arrow 106, the toner from each of the drums 78, 80, 82, and 84 is transferred to the outside surface of the belt 86. As a print medium, such as paper, travels along the path 108, the toner is transferred to the surface of the print medium and nip 112.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
sandwiching a doctor blade between a pair of brackets; and
mounting said brackets on an electrophotographic printer to bias the doctor blade against a developer roll.

2. The method of claim 1 including using only two screws to secure said doctor blade to said printer.

3. The method of claim 1 including providing a locator post on said printer so that the post passes through holes in said brackets and said doctor blade to align said doctor blade on said printer.

4. The method of claim 3 including providing a pair of spaced locating posts and spaced holes along the length of said doctor blade and said brackets to mount said doctor blade in a fixed position on said printer.

5. The method of claim 4 including using a pair of spaced threaded fasteners to secure said brackets and said doctor blade to said printer.

6. The method of claim 1 including using a pair of L-shaped brackets to sandwich said doctor blade.

7. The method of claim 6 including supporting at least one of said L-shaped brackets on a land on said printer.

8. The method of claim 7 wherein said L-shaped brackets have a shorter end and a longer leg, supporting said longer leg on said land.

9. The method of claim 8 including overlapping the longer leg of one bracket over the longer leg of the other bracket so that said longer leg of one bracket extends beyond the longer leg of the other bracket.

10. The method of claim 9 including providing said overlap of one bracket counterclockwise with respect to the other bracket.

11. A doctor blade assembly comprising:
a first L-shaped bracket;
a second L-shaped bracket; and
a doctor blade sandwiched between said L-shaped brackets.

12. The assembly of claim 11 wherein one of said brackets is shorter than the other.

13. The assembly of claim 11 wherein said L-shaped brackets include a shorter leg and a longer leg.

14. The assembly of claim 13 wherein said brackets are nested.

15. The apparatus of claim 11 wherein said brackets enable said doctor blade to be secured to a printer using only two screws.

16. The apparatus of claim 15 wherein one of said brackets is shorter than the other end to allow for flexing of the doctor blade away from the developer roll.

17. A printer comprising:
a housing;
a doctor blade; and
a pair of brackets sandwiching said doctor blade.

18. The printer of claim 17 wherein said brackets are L-shaped.

19. The printer of claim 18 wherein said L-shaped brackets have a shorter leg and a longer leg, one of said longer legs resting on said housing.

20. The printer of claim 19 wherein said doctor blade is held on said housing only two screws.

21. The printer of claim 20 including a pair of mounting posts extending from said housing through said brackets and through said doctor blade.

22. The printer of claim 17 including a developer roll, said brackets biasing said doctor blade against said developer roll.

23. The printer of claim 22 wherein said doctor blade is a cantilevered leaf spring.

24. The printer of claim 23 wherein said brackets are more rigid than said doctor blade.

25. The printer of claim 17 including a locator post on said housing, said post passing through holes of said brackets and said doctor blade to align said doctor blade on said housing.

26. The printer of claim 25 including a pair of space locating posts on said housing, space holes along the length of said doctor blade in said brackets to mount said doctor blade in a fixed position on said housing.

27. The printer of claim 17 including a land on said housing, said L-shaped brackets including a first portion and a second portion, said first portion being longer than said second portion, said second portion sandwiching said doctor blade and said first portion resting on said land on said housing.
